(19) United States
(12) Patent Application Publication
(10) Pub. No.: US 2006/0234661 A1
(43) Pub. Date: Oct. 19, 2006

(54) Semiconductor integrated circuit for communication and portable communication terminal

(76) Inventors: Kenji Toyota, Tokyo (JP); Ryoichi Takano, Tokyo (JP); Noriyuki Kurakami, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/404,818

(22) Filed: Apr. 17, 2006

(30) Foreign Application Priority Data
Apr. 18, 2005 (JP) 2005-119162

(51) Int. Cl. H04B 1/06; H04B 1/28; H04B 7/00

(52) U.S. Cl. 455/252.1; 455/333

(57) ABSTRACT

The present invention provides a semiconductor integrated circuit for communication (radio frequency IC) capable of detecting and correcting variations in an amplitude loop band of a transmission circuit having a phase control loop and an amplitude control loop without using an external measuring apparatus. In a semiconductor integrated circuit for communication (radio frequency IC) including a transmission circuit having a phase control loop for controlling the phase of a carrier wave and an amplitude control loop for controlling the amplitude of a transmission output signal, a calibration circuit for detecting variations in a loop gain of the amplitude control loop and correcting the loop band is provided. The calibration circuit detects variations in a loop gain by comparing a feedback signal with an output signal of a modulation circuit while changing electric parameters of any of circuits on the amplitude control loop step by step, and corrects the loop band by changing characteristics of any of the circuits on the amplitude control loop in accordance with the detected variations.

### CROSS-REFERENCE TO RELATED APPLICATION

The present application claims priority from Japanese patent application No. 2005-119162 filed on Apr. 18, 2005, the content of which is hereby incorporated by reference into this application.

### BACKGROUND OF THE INVENTION

The present invention relates to a technique effectively applied to a semiconductor integrated circuit for communication having therein a transmission circuit which is mounted on a radio communication apparatus such as a portable telephone, modulates a transmission signal, up-converts the signal, and outputs the resultant signal, and a portable communication terminal on which the semiconductor integrated circuit for communication is mounted. More particularly, the invention relates to a technique for correcting variations in a frequency band of an amplitude control loop in a transmission circuit having a phase control loop and the amplitude control loop and performing phase adjustment in the phase control loop and amplitude modulation in the amplitude control loop.

Hitherto, there is a scheme called GSM (Global System for Mobile Communication) as one of communication schemes of a wireless communication apparatus (mobile communication apparatus) such as a cellular phone. The GSM uses a phase modulation scheme called GMSK (Gaussian Minimum Shift Keying) for shifting the phase of a carrier wave in accordance with transmission data.

A cellular phone of the GSM or the like in recent years is provided with not only the above-described modulation scheme but also a communication scheme called EDGE (Enhanced Data Rates for GMS Evolution) having 3π/8 rotating 8-PSK (Phase Shift Keying), and a system performing communications while changing the modulation schemes is being practically used. The 8-PSK modulation is a scheme of modulating each of a phase component and an amplitude component of a carrier wave, thereby increasing data transmission rate.

Methods of realizing an EDGE transmission circuit having the 8-PSK modulation mode include a direct up-conversion method and a phase/amplitude separate modulation method. The direct up-conversion method is a method of directly converting signals obtained by performing phase modulation and amplitude modulation on carrier waves to signals of transmission frequencies. The phase/amplitude separate modulation method is a method of separating a signal of an intermediate frequency subjected to phase modulation and amplitude modulation into a phase component and an amplitude component, after that, feeding back the phase component in a phase control loop, feeding back the amplitude component in an amplitude control loop, combining the resultants in an amplifier, and outputting the resultant signal.

In the frequency bands of those loops, to increase transmission precision and reduce noise in a reception band, it is important that variations in the gains are small. Hitherto, techniques of correcting variations in the frequency bands of the phase control loop and the amplitude control loop have been proposed. A technique for correcting variations in the frequency band of the amplitude control loop is described in, for example, Japanese Unexamined Patent Publication No. 2004-007445.

In the method of correcting variations of the frequency band of an amplitude control loop in the filed application, amplitude modulation is performed on an output of a power amplifier in the amplitude control loop, sidebands at, at least, two modulation frequencies are measured, and a loop band is calculated from the attenuation amount. Values for correcting the loop band from calculation results are pre-stored in a nonvolatile memory. Before transmission, the values are read and used to correct the gain of an amplifier on the amplitude control loop, thereby correcting variations in the loop band.

### SUMMARY OF THE INVENTION

The method of correcting variations in the amplitude loop band in the filed invention needs a measuring apparatus such as a spectrum analyzer for measuring sidebands. Consequently, it takes time to set the measuring apparatus and read measurement data, and the cost increases. Since the measuring apparatus is necessary, a correction can be made only at the time of shipment of the wireless communication apparatus. That is, since only corrections based on measurement results under environments different from that at the time of actual use, such as power supply voltage and temperature can be made, there is a drawback such that improvement in transmission precision and reduction in noise in a reception band cannot be sufficiently performed.

An object of the present invention is to provide a semiconductor integrated circuit for communication (radio frequency IC) capable of detecting and correcting variations in an amplitude loop band of a transmission circuit having a phase control loop and an amplitude control loop without using an external measuring apparatus.

Another object of the invention is to provide a semiconductor integrated circuit (radio frequency IC) for communication capable of reducing the cost required to correct variations in the amplitude loop band of a transmission circuit having a phase control loop and an amplitude control loop and sufficiently achieving improvement in transmission precision and reduction in noise in a reception band.

The above and other objects and novel features of the present invention will become apparent from the description of the specification and appended drawings.

Outline of representative ones of inventions disclosed in the application will be briefly described as follows.

In a semiconductor integrated circuit for communication (radio frequency IC) including a transmission circuit having a phase control loop for controlling the phase of a carrier wave and an amplitude control loop for controlling the amplitude of a transmission output signal, a calibration circuit for detecting variations in a loop gain of the amplitude control loop and correcting the loop band is provided. The calibration circuit detects variations in a loop gain by comparing a feedback signal with an output signal of a modulation circuit while changing electric parameters of any of circuits on the amplitude control loop step by step, and corrects the loop band by changing characteristics of any of the circuits on the amplitude control loop in accordance with the detected variations.

More concretely, on a forward path extending from an amplitude detection circuit as a component of the amplitude control loop to a power amplifier, a variable gain amplifier and a filter for giving a frequency band of the amplitude control loop are provided. In addition, a current circuit which passes an alternate current to the filter at the time of calibration and whose current value can be switched step by step, and a comparator for comparing amplitude of a feedback signal with amplitude of an output signal of the modulation circuit are provided. The gain of the variable gain amplifier is changed only by an amount corresponding to the current value of the alternate current when an output of the comparator changes.

Desirably, a register for holding a correction value for changing the gain of the variable gain amplifier is provided. Further, detection of variations in the loop gain by the calibration circuit is executed when a predetermined command is supplied from the outside.

Effects obtained by the representative ones of the inventions disclosed in the application will be briefly described as follows.

According to the present invention, a semiconductor integrated circuit for communication (radio frequency IC) capable of detecting and correcting variations in an amplitude loop band of a transmission circuit having a phase control loop and an amplitude control loop without using an external measuring apparatus can be realized. In addition, a semiconductor integrated circuit for communication (radio frequency IC) capable of reducing the cost required to correct variations in the amplitude loop band of a transmission circuit having a phase control loop and an amplitude control loop and sufficiently achieving improvement in transmission precision and reduction in noise in a reception band can be realized.

### BRIEF DESCRIPTION OF THE DRAWINGS

FIG. 1 is a block diagram showing a schematic configuration of an embodiment of a radio frequency IC to which the present invention is applied and a wireless communication system using the same.

FIG. 2 is a block diagram showing a configuration example of a phase comparator in a calibration executing circuit in a radio frequency IC in the embodiment.

FIGS. 3A to 3C are waveform charts showing waveforms of signals in parts of the phase comparator in the calibration executing circuit.

FIGS. 4A and 4B show the frequency characteristics of an open loop of the amplitude control loop; FIG. 4A is a graph showing the gain characteristic of the amplitude control loop, and FIG. 4B is a graph showing a phase characteristic of the amplitude control loop.

FIG. 5 is a graph showing the frequency characteristic of a closed loop of the amplitude control loop.

FIGS. 6A to 6C are waveform charts showing signal waveforms at the time of executing calibration on gain variations in the amplitude control loop in the embodiment.

FIG. 7 is a flowchart showing the procedure of calibrating gain variations in the amplitude control loop in the embodiment.

### DETAILED DESCRIPTION OF PREFERRED EMBODIMENTS

Embodiments of the present invention will now be described with reference to the drawings.

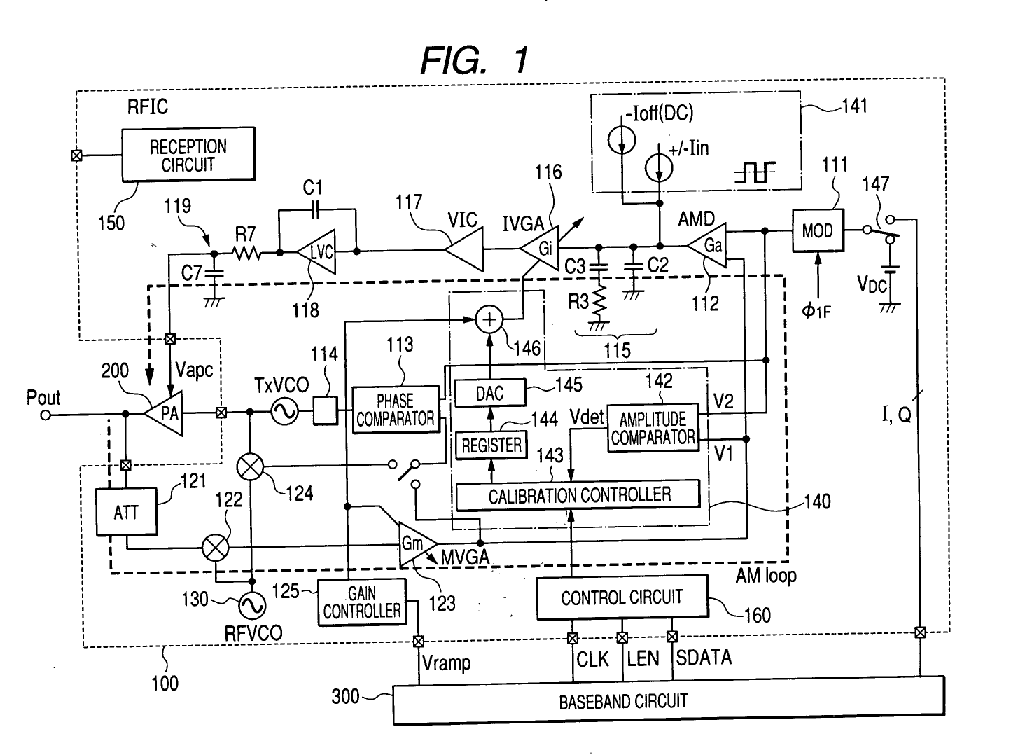

FIG. 1 shows a schematic configuration of an embodiment of a radio frequency IC to which the invention is applied and a wireless communication system using the same. The wireless communication system of FIG. 1 has a radio frequency IC 100 capable of performing GMSK modulation in a GSM mode and 8-PSK modulation in an EDGE mode and a radio frequency power amplifier (hereinbelow, simply called power amplifier) 200 for amplifying a transmission signal output from the radio frequency IC 100 and outputting the amplified transmission signal to a not-shown antenna.

The wireless communication system of FIG. 1 also includes a baseband circuit 300 for generating I and Q signals on the basis of transmission data and generating a control signal of the radio frequency IC 100, a band pass filter for eliminating unnecessary waves, and a transmission/reception switch. Although not limited, the baseband circuit 300 is formed as a semiconductor integrated circuit on a semiconductor chip different from a semiconductor chip on which the radio frequency IC 100 is formed.

The radio frequency IC 100 has a reception circuit 150 for demodulating and down-converting a signal received by an antenna, a transmission circuit for modulating and up-converting a transmission signal, and a control circuit 160 for controlling the whole chip. FIG. 1 shows a concrete configuration of the transmission circuit. Circuit blocks other than the reception circuit 150 and the control circuit 160 in the radio frequency IC 100 shown in FIG. 1 are circuit blocks constructing the transmission circuit. The transmission circuit of the embodiment has two control loops; a loop for phase control (hereinbelow, called phase control loop), and a loop for amplitude control (hereinbelow, called amplitude control loop).

To the control circuit 160, a clock signal CLK for synchronization, a data signal SDATA, and a load enable signal LEN as a control signal are supplied from the baseband circuit 300. When the load enable signal LEN is asserted to a valid level, the control circuit 160 sequentially latches the data signals SDATA transmitted from the baseband circuit 300 synchronously with the clock signal CLK, sets the data signals SDATA to an internal control register and, according to the set data, generates control signals for the circuits in the IC.

The power amplifier 200 includes a coupler for detecting a transmission power, a transistor for amplification, and an operation voltage generation circuit for generating an operation voltage of, for example, the transistor for amplification on the basis of a power control signal Vapc supplied from the radio frequency IC 100. The power amplifier 200 is constructed as a module by mounting discrete electronic parts such as an IC and a capacitor on an insulating substrate such as a single ceramic substrate.

The radio frequency IC 100 of the embodiment is obtained by forming circuits in a part surrounded by a broken line shown in FIG. 1 on a single semiconductor chip as semiconductor integrated circuits. Alternately, an oscillator TxVCO for transmission and a loop filter in the range of the broken line may be mounted as external parts on a single insulating substrate, thereby constructing a module.

The transmission circuit of the radio frequency IC 100 of the embodiment has a modulator 111 for performing quadrature modulation by mixing I and Q signals supplied from the baseband LSI 300 with intermediate frequency signals φIF such as 80 MHz whose phases are different from each other by 90 degrees. At a post stage of the modulator 111, an amplitude detector 112 for detecting the amplitude difference between the signal modulated by the modulator 111 and a signal from a feedback path of the amplitude control loop, and a phase comparator 113 for detecting the phase difference between the signal modulated by the modulator 111 and a signal from a feedback path of the phase control loop are provided. By the amplitude detector 112 and the phase comparator 113, the amplitude component and the phase component in a transmission signal are separated from each other.

At a post stage of the phase comparator 113, a loop filter 114 for generating a voltage according to the detected phase difference is provided. At a frequency according to an output voltage of the loop filter 114, the oscillator TxVCO for transmission oscillates. At a post stage of the amplitude detector 112, a loop filter 115 for generating a voltage according to the detected amplitude difference is provided. At a post stage of the loop filter 115, a variable gain amplifier (IVGA) 116, a voltage-current converter 117, an amplifier 118 for level shifting, and a filter 119 are provided. A voltage passed through the filter 119 is applied as the power control voltage Vapc to the power amplifier 200. A filter is constructed by the amplifier 118 for level shifting and a feedback capacitor C1.

In the feedback path of the amplitude control loop, an attenuator 121 for attenuating a signal extracted by a coupler from an output side of the power amplifier 200, a mixer 122 for down-converting the attenuated signal, and a variable gain amplifier (MVGA) 123 for amplifying the down-converted signal are provided. An output of the variable gain amplifier (MVGA) 123 is fed back to the input of the amplification detector 112 and the phase comparator 113.

On the other hand, in the phase control loop, although not limited, a signal extracted from an output of the oscillator TxVCO for transmission is down-converted by a mixer 124 and fed back to the phase comparator 113. The mixer 122 mixes an oscillation signal φRF of a high frequency generated by an RFVCO (local oscillator) 130 with the signal attenuated by the attenuator 121, and the mixer 124 mixes the oscillation signal φRF of the RFVCO with a signal extracted from an output of the TxVCO, thereby down-converting each of the signals to a signal of a frequency such as 80 MHz.

The amplitude control loop is constructed by the power amplifier 200, attenuator 121, mixer 122, variable gain amplifier (MVGA) 123, amplitude detector 112, loop filter 115, variable gain amplifier (IVGA) 116, voltage-current converter 117, amplifier 118 for level shifting, and power amplifier 200. The phase control loop is constructed by the oscillator TxVCO for transmission, mixer 124, phase comparator 113, loop filter 114, and oscillator TxVCO for transmission. In this case, a change-over switch connects the mixer 124 to the phase comparator 113. The feedback path of the amplitude control loop may be used as a feedback path common to the two control loops. In this case, the change-over switch connects the variable gain amplifier (MVGA) 123 to the phase comparator 113.

The gains of the variable gain amplifier (MVGA) 123 and the variable gain amplifier (IVGA) 116 are set by a gain controller 125 on the basis of an output level instruction signal Vramp from the baseband LSI 300. The gain controller 125 decreases a gain Gm of the variable gain amplifier (MVGA) 123 at the time of increasing a gain Gi of the variable gain amplifier (IVGA) 116, and increases the gain Gm of the variable gain amplifier (MVGA) 123 at the time of decreasing the gain Gi of the variable gain amplifier (IVGA) 116. That is, the gains of the amplifiers are controlled so that the sum (Gm+Gi) of the gains of the two amplifiers becomes almost constant. By the control, even when the signal Vramp changes, the closed loop gain of the amplitude control loop is prevented from fluctuating.

On the other hand, when the output level instruction signal Vramp is set to be high, the gain Gi of the variable gain amplifier (IVGA) 116 on a forward path is increased, the output control voltage Vapc is increased, and the amplification factor of the power amplifier 200 is increased. When the signal Vramp is set to be low, the gain Gi of the variable gain amplifier (IVGA) 116 on the forward path is decreased, the output control voltage Vapc is decreased, and the amplification factor of the power amplifier 200 is decreased. That is, the output power of the power amplifier 200 is controlled in accordance with the output level instruction signal Vramp.

The transmission circuit of the embodiment has a calibration executing circuit 140 for correcting gain variations in the amplitude control loop. The calibration executing circuit 140 includes a current circuit 141, an amplitude comparator 142, a calibration controller 143, a register 144 for setting a correction value AO, a DA converter 145 for converting a set value of the register to an analog signal, and an adder 146 for adding the converted signal and an output of the gain controller 124. Since the current circuit 141 passes current to the loop filter 115 at the post stage of the variable gain amplifier (IVGA) 116 and adds/subtracts a predetermined current to/from the output current of the variable gain amplifier (IVGA) 116, it can be regarded as a circuit of changing electric parameters of the variable gain amplifier (IVGA) 116.

In the case where a signal that designates the gain is supplied as a digital value (control code) from the gain controller 125 to the variable gain amplifier (IVGA) 116 and the variable gain amplifier (IVGA) 116 changes a current value in accordance with the code, the DA converter 145 is unnecessary. That is, a signal obtained by adding the digital correction value AO to the control code that designates the gain to be supplied from the gain controller 124 to the variable gain amplifier (IVGA) 116 can be supplied to the variable gain amplifier (IVGA) 116.

A change-over switch 147 is also provided which supplies a direct current voltage VDC in place of the I and Q signals to the modulator 111 at the time of calibration. The current circuit 141 and the change-over switch 147 are controlled by a control signal from the calibration controller 143. The calibration controller 143 can be also constructed integrally with the control circuit 160 of the whole chip or as a part of the control circuit 160. The frequency of an oscillation signal φIF of an intermediate frequency as another input of the modulator 111 is switched according to the transmission frequency at the time of actual transmission. At the time of calibration, the oscillation signal φIF is input as a signal of a predetermined frequency such as 80 MHz at the time of calibration.

The amplitude comparator 142 detects the difference between the amplitude of an output signal of the modulator 111 and the amplitude of a feedback signal from the feedback path (an output signal of the variable gain amplifier MVGA). The calibration controller 143 is constructed as a sequencer which starts calibration on receipt of a command code instructing start of calibration from the baseband circuit 300, and determines a correction value on the basis of a detection signal from the amplitude comparator 142. The determined correction value is once output to the baseband LSI 300 on the outside of the chip and stored in a memory in the baseband LSI 300. In place of providing the change-over switch 147, the direct current voltage VDC may be supplied instead of the I and Q signals from the baseband LSI 300 at the time of calibration.

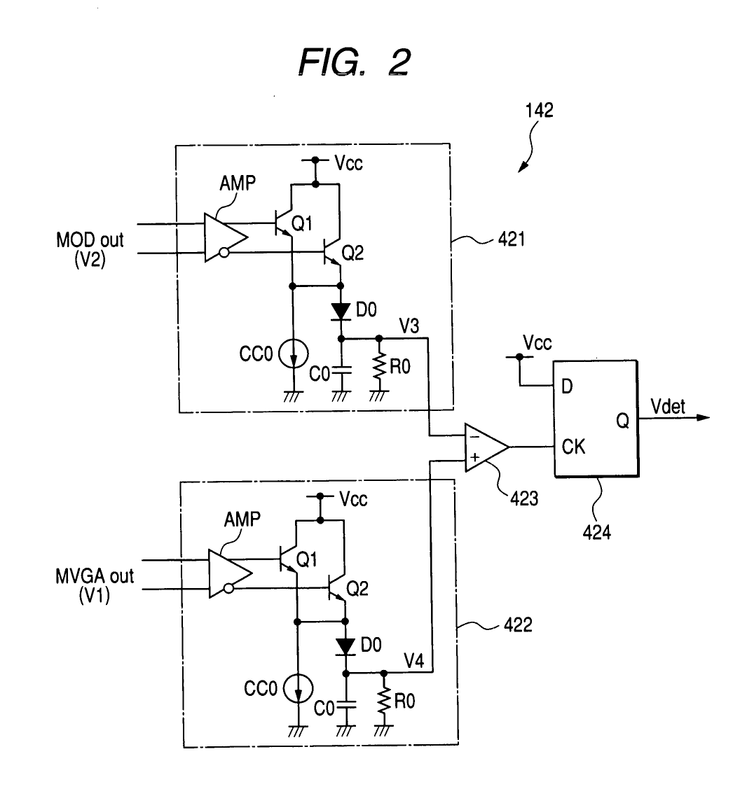

FIG. 2 shows a concrete circuit example of the amplitude comparator 142. The amplitude comparator 142 includes a detector 421 which receives an output V2 of the modulator 111, a detector 422 which receives an output V1 of the variable gain amplifier (MVGA) 123, a comparator 423 for comparing the output voltages of the detectors 421 and 422, and a D flip flop 424.

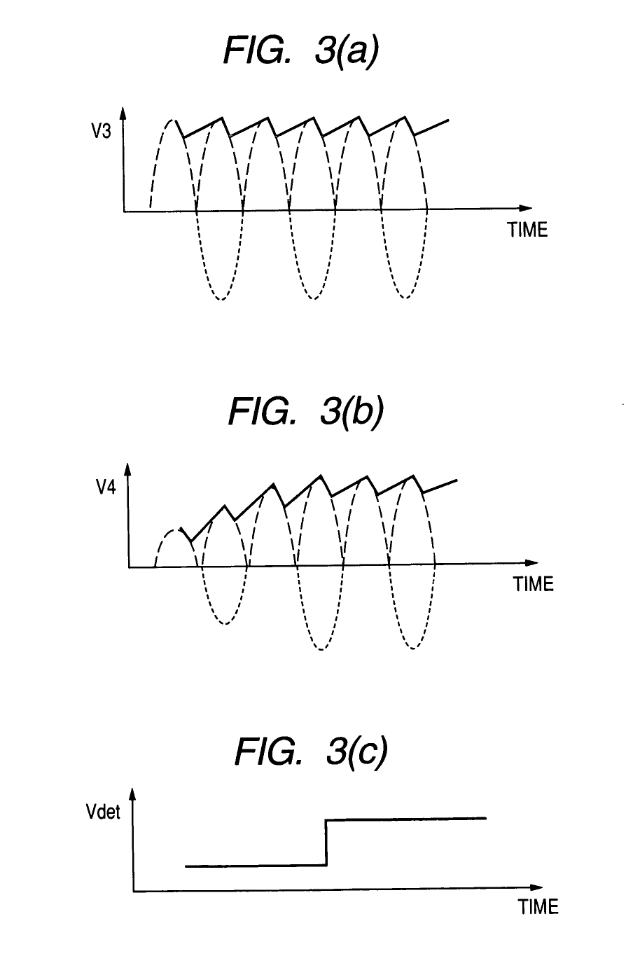

The detector 421 performs full-wave rectification on the output V2 of the modulator 111 and outputs a voltage V3 corresponding to an envelope as shown in FIG. 3A. The detector 422 performs full-wave rectification on the output V1 of the MVGA 123 and outputs a voltage V4 corresponding to an envelope as shown in FIG. 3B. The comparator 423 compares the output voltages V3 and V4 of the detectors 421 and 422. When the voltage V4 becomes higher than the voltage V3, an output of the comparator 423 changes from the low level to the high level.

When the flip flop 424 performs latching operation in response to an output of the comparator 423 and an output of the comparator 423 changes to the high level, even if the output changes back to the low level later, the output of the flip flop 424 maintains the high level. Each of the detectors 421 and 422 has a differential amplifier AMP, transistors Q1 and Q2 connected in parallel and turned on/off according to the differential output of the amplifier AMP, a constant current source CC0 connected between a common emitter of the transistors Q1 and Q2 and the ground point, a diode D0, an output stabilization capacitor C0, and a resistor R0 for reset.

In the embodiment of FIG. 1, the currents passed from the current circuit 141 to the loop filter 115 are a constant offset current Ioff and an alternate current ±Iin having a predetermined amplitude. The offset current Ioff is, for example, −4 μA, and the alternate current ±Iin is alternate current which fluctuates at a frequency fin such as 4.33 MHz in the range of, for example, −3.5 μA to 3.5 μA. In the embodiment, the currents Ioff and ±Iin are added to each other and the resultant is passed to the loop filter 115. Therefore, the current passed to the loop filter 115 at the time of calibration fluctuates in the range of −0.5 to 7.5 μA.

When the alternate current ±Iin is passed to the loop filter 115, an output of the power amplifier 200 is amplitude-modulated, and the envelope fluctuates at the frequency fin. The envelope similarly fluctuates after the frequency is converted to the intermediate frequency band by the mixer 122, and the envelope of the output of the variable gain amplifier (MVGA) 123 also fluctuates at the frequency fin. When the frequency fin is set to be sufficiently high, the fluctuation amount of the envelope tends to increase as the loop band of the amplitude control loop becomes higher.

In the embodiment, the loop band of the amplitude control loop is designed so that the open loop gain becomes 0 dB at 1.8 MHz for the reason that it is optimum to increase the transmission modulation precision and suppress the influence of transmission noise which occurs in the reception band as much as possible. The higher the band is, the higher the modulation precision is. However, when the band is too high, transmission noise increases. On the other hand, when the band is too low, the transmission noise can be reduced but the modulation precision deteriorates. When the band is too high or too low, a phase margin of the loop is narrowed, and the loop becomes unstable.

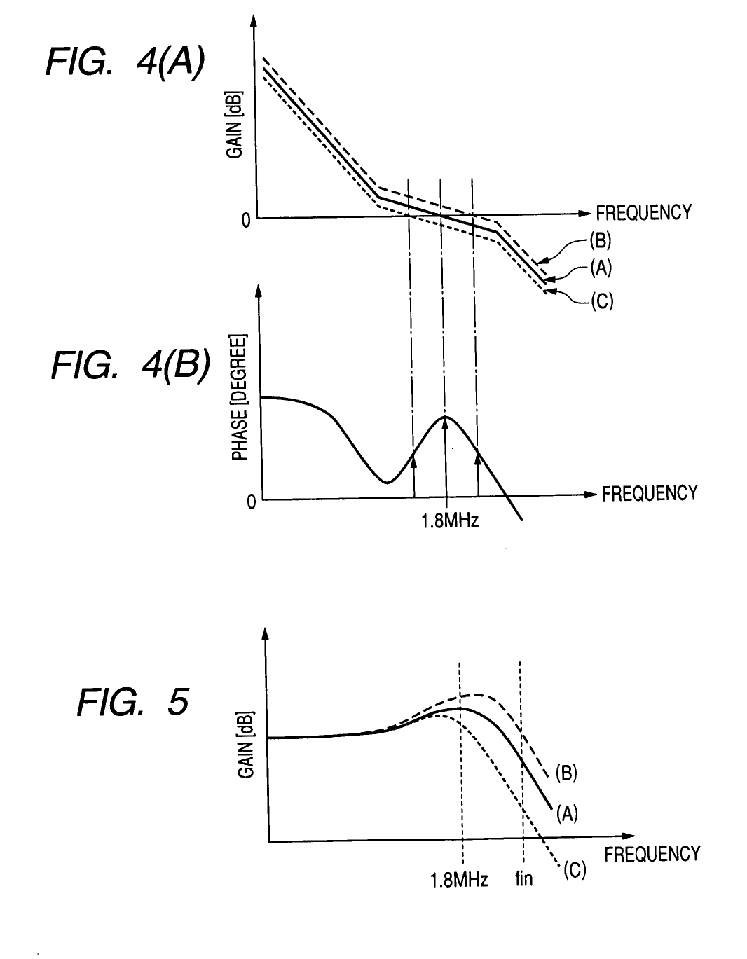

Gain variations in the amplitude control loop in the embodiment and the necessity of correction of the gain variations will be described hereinbelow. FIGS. 4A and 4B show the frequency characteristics of the open loop of the amplitude control loop. FIG. 4A shows the gain characteristic of the amplitude control loop, and FIG. 4B shows the phase characteristic of the amplitude control loop. In the embodiment, it is designed so that the open loop gain becomes 0 dB at 1.8 MHz. When the open loop gain fluctuates, the gain characteristic fluctuates as shown by broken lines in FIG. 4A.

It is understood from FIG. 4B that in the case where the open loop gain becomes 0 dB at 1.8 MHz, the phase margin becomes locally maximum. When the gain characteristic fluctuates, the phase margin decreases. Decrease in the phase margin deteriorates stability of the amplitude control loop, so that it has to be avoided. Therefore, when the open loop gain of the amplitude control loop deviates from 1.8 MHz as a target value due to manufacture variations, the deviation has to be corrected.

FIG. 5 shows the frequency characteristic of the closed loop of the amplitude control loop. In FIG. 5, the solid line A shows the characteristic of the case where there are no gain variations and it is understood that the gain peak is at 1.8 MHz. In the embodiment of FIG. 1, in the case where the frequency fin of the alternate current ±Iin having the predetermined amplitude passed to the loop filter 115 by the current circuit 141 is set to be higher than 1.8 MHz, the closed loop gain shifts to the higher side when the open loop gain varies to the higher side as shown by a broken line B, and shifts to the lower side when the open loop gain varies to the lower side as shown by a dot line C.

That is, the gain fluctuation amount is almost proportional to the frequency fluctuation amount of the loop band. The amplitude of the output of the variable gain amplifier (MVGA) 123 on the feedback path of the amplitude control loop also changes in proportional to variations in the closed loop gain. From the phenomenon, it was found that the loop band of the amplitude control loop can be measured from the fluctuation amount of the envelope of the output of the variable gain amplifier (MVGA) 123. In the embodiment, therefore, the alternate current ±Iin to be passed to the filter 115 of the amplitude control loop is changed, the amplitude of the output of the variable gain amplifier (MVGA) 123 is detected, the loop band of the amplitude control loop is measured, and gain variations are corrected.

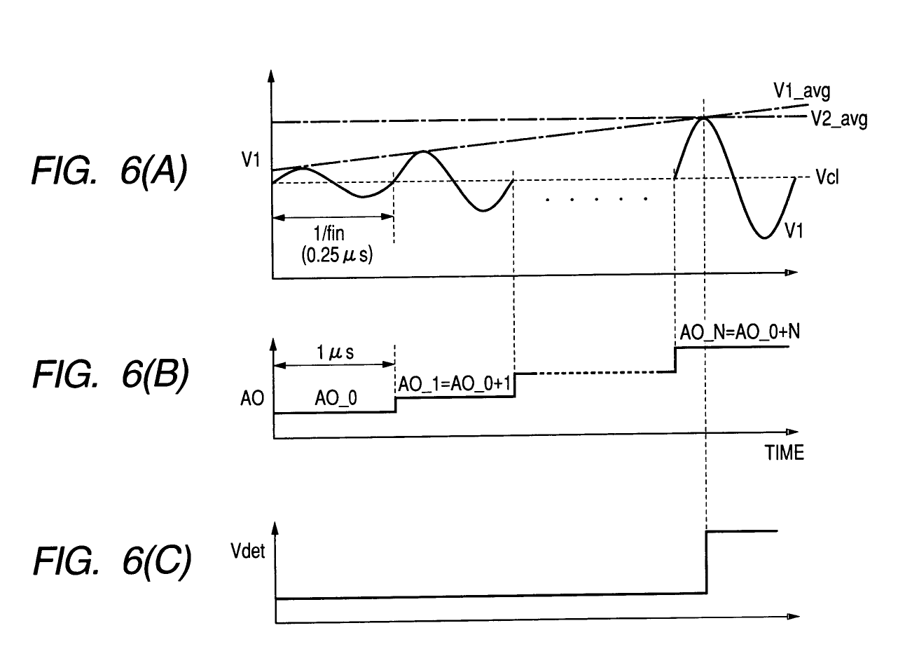

FIGS. 6A to 6C show signal waveforms at the time of executing calibration on gain variations of the amplitude control loop in the embodiment.

FIG. 6A shows the waveform of the output V1 of the variable gain amplifier (MVGA) 123 to be supplied from the feedback path to the amplitude detector 112. In the output waveform, as shown in FIG. 6B, the amplitude changes according to switching of the control code AO which changes the gain of the variable gain amplifier (IVGA) 116 on the forward path. In FIG. 6A, V1c denotes center potential of the output V1 of the MVGA, V1_avg denotes the amplitude of an output of the MVGA, that is, an average level of the envelope, and V2_avg indicates the amplitude of a reference signal (sine wave of 80 MHz) supplied from the modulator 111 to the amplitude comparator 142 at the time of calibration, that is, the average level of the envelope.

In the embodiment of FIG. 1, by changing the offset current Ioff to be passed to the loop filter 115 by the current circuit 141, the center potential V1c of an output of the MVGA is adjusted. By changing the current value of the alternate current ±Iin and the gain Gi of the IVGA, the average level V1_avg of the envelope of the output of the MVGA can be adjusted. The offset current Ioff may be a negative value or a current led from the loop filter 115.

Concretely, Ioff=−4 μA, and ±Iin=−3.5 to +3.5 μA, and the frequency fin of ±Iin is set to almost 4 MHz. The gain Gi of the IVGA is increased by the control code AO by 0.5 dB per 1 μsec. Further, the range of the control code AO is determined so that the loop band becomes 1.8 MHz when the control code AO is set to an intermediate control code AOc (=0) in a state where there are no gain variations in the amplitude control loop. First, the control code AO_0 for setting the gain Gi of IVGA is selected so that the loop band becomes 1.8 MHz at the upper limit (maximum allowable value) of gain variations of the amplitude control loop. The control code AO_0 may be a value that instructs a gain smaller than the gain at the time of AOc. The control code AO is a binary code of, for example, six bits and the gain Gi of the IVGA can be adjusted in 64 levels. The difference between V2_avg and V1_avg is a value determined by Ioff and the amplitude of ±Iin.

It is assumed that the control code AO is increased from AO_0, AO_1, AO_2, . . . to AO_N, and an output of the amplitude comparator 142 changes to the high level. If AO_N is larger than AOc (=0), the loop band varies to the lower side. When AO_N is smaller than AOc (=0), the loop band varies to the higher side. Therefore, at the time of actual transmission, by setting a gain obtained by adding a gain corresponding to the control code AO_N to the gain corresponding to the output level instruction signal Vramp from the baseband in the IVGA, an operation can be performed in a state where variations in the loop band are corrected.

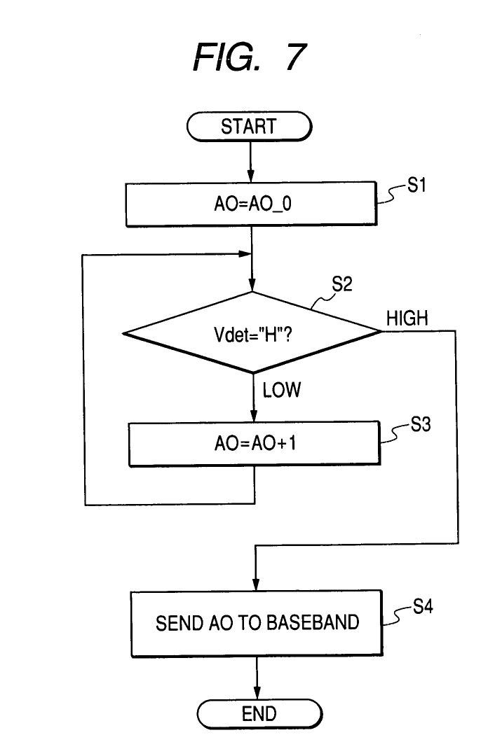

Next, the procedure of calibrating gain variations in the amplitude control loop in the embodiment will be described in detail with reference to the flowchart of FIG. 7. The calibration starts when a predetermined command code that instructs execution of calibration from an external device (including a baseband circuit) is supplied to the control circuit 160.

When the calibration execution command is given, the control circuit 160 starts the calibration controller 143. First, the calibration controller 143 sets the control code CO for setting the gain Gi of the IVGA to AO_0 and supplies the resultant to the IVGA (step S1). In the embodiment, for example, the output level instruction signal Vramp for maximizing an output of the power amplifier 200 is supplied from an external device to the gain controller 125 before start of the calibration. The gain Gi of the IVGA is set to a gain obtained by adding the gain corresponding to AO_0 to the gain corresponding to Vramp.

Next, the calibration control circuit 143 determines whether an output of the amplitude comparator 142 is at the high level or not (step S2). When it is determined that an output of the amplitude comparator 142 is not at the high level, that is, at the low level, the control code AO is increased by one level (+1) in the following step S3, and the calibration controller 143 returns to step S2 and makes the determination again.

By increasing the control code AO by one level, the gain Gi of the IVGA is increased only by 0.5 dB, and the amplitude of the output V1 of the MVGA supplied to the amplitude comparator 142 is increased. When it is determined in step S2 that an output of the amplitude comparator 142 is at the high level, the program moves to step S4 where the control code AO_N is output as a value of correcting the gain variations of the amplitude control loop to the outside, and finishes the calibration.

An external device which receives the control code AO_N stores the code into a nonvolatile memory in the baseband circuit. The baseband circuit reads the correction value from the nonvolatile memory at power-on or just before start of transmission, and supplies it to the calibration controller 143. The control circuit 160 makes the correction value AO_N held in the register 144 and sets a gain obtained by adding the gain corresponding to the correction value AO_N to the gain corresponding to the output level instruction signal Vramp supplied from the baseband circuit 300 to the gain controller 125 in the IVGA.

As described above, in the embodiment, the control code AO_N obtained by the calibration is output as the gain variation correction value of the amplitude control loop to an external device on assumption that gain variations in the amplitude control loop are measured in the final process of a manufacture line before shipment. In the case of measuring variations in the band of the amplitude control loop in the manufacture line, a calibration execution command is given from a tester or the like.

Also in a state where the radio frequency IC to which the calibration circuit of the embodiment is applied is assembled in an actual system, calibration can be performed. In this case, it is sufficient to give the calibration execution command from the baseband circuit 300. After the calibration, the gain variation correction value AO_N of the amplitude control loop may be automatically set in the internal register 144 without being output to the outside. Although calibration of the amplitude control loop is executed on receipt of a predetermined command from an external device, the calibration may be automatically executed at the time of power on or the like.

Although the present invention achieved by the inventors herein has been concretely described on the basis of the embodiment, the invention is not limited to the embodiment. For example, in the embodiment, the voltage Vapc generated by the amplitude control loop is supplied to a power amplifier to control an output power. The invention can be also applied to a configuration in which a variable gain amplifier is provided at a post stage of the oscillator TxVCO for transmission, and the gain of the amplifier is controlled with the voltage Vapc generated by the amplitude control loop.

At the time of calibration, as the control code AO_0 for setting the gain Gi of the IVGA, a value different from that in the embodiment may be selected first. Specifically, in the foregoing embodiment, the control code AO_0 is selected so that the loop band becomes 1.8 MHz at the upper limit (maximum allowable value) of the gain variations in the amplitude control loop. Alternately, a control code that gives a gain corresponding to the lower limit at which the amplitude control loop does not oscillate or a gain higher than the gain may be selected as AO_0.

Further, in the embodiment, the calibration is performed without considering the phase difference between the output V1 of the MVGA and the output V2 of the modulation circuit. In an actual radio frequency IC, an error may occur in an output of the amplitude comparator 142 due to the phase difference between the output V1 of the MVGA and the output V2 of the modulation circuit. Consequently, a value obtained by adding or subtracting an error amount to/from the detected correction value AO_N may be set as a final correction value in consideration of an error due to the phase difference between the output V1 of the MVGA and the output V2 of the modulation circuit.

Although the loop band is corrected by adjusting the gain of the variable gain amplifier on the forward path in accordance with the detected gain variations of the amplitude control loop in the foregoing embodiment, the loop band may be corrected by adjusting characteristics of another circuit in the amplitude control loop. For example, by changing the capacitance value of the capacitor C1 constructing a filter in cooperation with the amplifier 118 for level shifter shown in FIG. 1 by providing a plurality of capacitive elements and switch elements connected to the capacitive elements in series, the loop band can be corrected. The value of a capacitor C7 in the filter 119 may be changed or the gain Ga of the amplitude detector 112 may be changed.

Further, in the foregoing embodiment, the calibration circuit for correcting variations in the frequency band of the amplitude loop has been described. It is desirable to separately provide a calibration circuit for correcting variations in the frequency band of a phase loop and make a correction. Since variations in the frequency band of the phase loop can be corrected independently of correction of variations in the frequency band of the amplitude loop, the description will not be given. Although the invention which is applied to the radio frequency IC adaptable to an EDGE mode of performing both phase modulation and amplitude modulation has been described, the present invention is not limited to the embodiment but can be also applied to a radio frequency IC in which a transmission circuit has a phase control loop and an amplitude control loop. By the invention, similar effects are produced.

Although the case of applying the present invention achieved by the inventors herein to a radio frequency IC used for a wireless communication system such as a cellular phone as the field of utilization as the background of the invention has been described above, the present invention is not limited to the embodiment but can be generally used for a radio frequency IC for wireless LAN radio frequency IC and semiconductor integrated circuits for communication.

What is claimed is:

1. A semiconductor integrated circuit for communication, including a transmission circuit having a phase control loop for controlling phase of a carrier wave and an amplitude control loop for controlling amplitude of a transmission output signal, comprising
a calibration circuit which compares a feedback signal with an output signal of a modulation circuit while changing electric parameters of any of circuits on the amplitude control loop step by step, detects variations in a loop gain, and corrects a loop band by changing the characteristics of any of the circuits on the amplification control loop in accordance with the detected variations.

2. A semiconductor integrated circuit for communication, including a transmission circuit having a phase control loop for controlling phase of a carrier wave and an amplitude control loop for controlling amplitude of a transmission output signal, comprising
a gain variation detection circuit which detects variations in a loop gain by comparing a feedback signal with an output signal of a modulation circuit while changing electric parameters of any of circuits on the amplitude control loop step by step, and outputs a detection result.

3. A semiconductor integrated circuit for communication according to claim 2, wherein the characteristics of any of the circuits on the amplitude control loop are changed by a correction value generated on the basis of the detection result output from the gain variation detection circuit, thereby correcting a loop band.

4. A semiconductor integrated circuit for communication according to claim 3, further comprising a register for holding the correction value for changing the characteristics of any of the circuits on the amplitude control loop.

5. A semiconductor integrated circuit for communication according to claim 3, wherein any of the circuits on the amplitude control loop, whose characteristics are changed by the correction value, is a variable gain amplifier.

6. A semiconductor integrated circuit for communication according to claim 2, comprising, on a forward path extending from an amplitude detection circuit as a component of the amplitude control loop to a power amplifier, a variable gain amplifier and a filter for giving a frequency band of the amplitude control loop, and comprising: a current circuit which passes an alternate current of a predetermined frequency to the filter at the time of calibration and whose current value can be switched step by step; and a comparator for comparing amplitude of a feedback signal with amplitude of an output signal of the modulation circuit,
wherein variations in a loop gain are detected on the basis of output of the comparator.

7. A semiconductor integrated circuit for communication according to claim 4, wherein a predetermined correction value is stored in the register prior to a transmitting operation, and a loop band of the amplitude control loop is corrected on the basis of the correction value.

8. A portable communication terminal comprising: a semiconductor integrated circuit for communication according to claim 2; and a second semiconductor integrated circuit in which a baseband circuit is formed,
wherein the second semiconductor integrated circuit has a nonvolatile memory circuit, and a correction value generated on the basis of a detection result output from the gain variation detection circuit is stored in the memory circuit.

9. A portable communication terminal according to claim 8, wherein the correction value is read from the memory circuit, supplied to the semiconductor integrated circuit for communication, and set in the register before start of transmission or at power-on.

10. A portable communication terminal according to claim 8, further comprising a power amplifier for amplifying a transmission signal whose phase is modulated by the semiconductor integrated circuit for communication,
wherein a signal from a forward path of the amplitude control loop is supplied to the power amplifier, an output power of the power amplifier is controlled, and a signal extracted from an output side of the power amplifier is fed back as the feedback signal.
